(19) United States
(12) Patent Application Publication
(10) Pub. No.: US 2008/0067370 A1
(43) Pub. Date: Mar. 20, 2008

(54) Electron microscope and scanning probe microscope calibration device

(76) Inventor: John Patrick McCaffrey, (US)

Correspondence Address: JOHN MCCAFFREY, 64 WESTPARK DRIVE, OTTAWA, ON, K1B-3E5, US

(21) Appl. No.: 11/428,388

(22) Filed: Jul. 1, 2006

(51) Int. Cl. G12B 13/00

(52) U.S. Cl. 250/306

(57) ABSTRACT

An electron microscope or scanning probe microscope calibration device can provide accurate length calibrations in the ranges from sub-nanometer to several micrometers. The device material consists of a series of periodic structures grown on a single crystal semiconductor substrate. The device material is prepared as a cross-sectional sample for viewing the periodic structures in an electron or scanning probe microscope. The measurements of the indicator features are very accurate and verifiable, being directly referenced to the crystal lattice spacing of the substrate material of the device, as determined by cross-sectional TEM or XRD of periodic structures. The device provides consistency and accuracy across these calibration ranges, and between electron and scanning probe microscopes.

### BACKGROUND OF THE INVENTION

The invention relates to a method and device for calibrating electron microscopes and scanning probe microscopes, for example a scanning electron microscope (SEM) or an atomic force microscope (AFM), but the invention is applicable to any type of electron or scanning probe microscope requiring calibration.

In an instrument that is capable of providing images or measurements over magnification ranges from sub-nanometer to several micrometers, it is often difficult to provide an accurate and consistent magnification calibration over all of these ranges. Similarly, when such an instrument is capable of providing additional information such as chemical or crystalline identification or probe characterization, accurate spatial calibration of these modes is essential. This invention relates to the provision of consistency under these conditions that occur in electron or scanning probe microscopes.

An accurate calibration of the magnification of images is critical in quantitative SEM and AFM. Manufacturers of theses instruments provide nominal values of magnification for each imaging condition, but these values have been observed to have significant errors. These variations can occur due to differences between imaging conditions, aging electronic components, variations in lenses in individual electron microscopes or variations in scanner components in scanning probe microscopes. For quantitative electron microscopy or scanning probe microscopy, calibrations of the individual instruments must be made so that the actual length values of features imaged by these microscopes can be accurately known.

National Measurement Institutes do not currently provide traceable length measurements for features smaller than about one half of a micrometer. The few available SEM and AFM calibration samples for the sub-nanometer to micrometer range are typically made by photolithographic means on substrate surfaces. Drawbacks of this approach are poor feature edge definition and minimal feature sizes of approximately 0.1 micrometer.

The deficiencies of a formal certification of length and access to sub-nanometer to micrometer reference feature sizes can be rectified by referencing lengths to the natural length constants provided by the crystal lattice spacings available in a single crystal substrate material upon which the device if formed. By using these crystal lattice spacings as unit reference lengths, larger grown-in multilayer structures on the calibration device can be internally calibrated. Grown-in structures may include epitaxial, polycrystalline or amorphous layers with precisely controlled layer thicknesses. When viewed in cross-section, the crystal lattice spacing of the substrate material can be used as an accurate unit length for verifying all dimensions in the grown-in multilayer structure. The grown-in multilayer structures can then be used as calibrated lengths, ranging from sub-nanometer length scales up to and beyond micrometer length scales.

To determine the layered structure dimensions, a representative sample of the device material can be imaged in cross-section by transmission electron microscopy (TEM). The crystalline atomic lattice of the substrate can be imaged by TEM and utilized as the unit length for specifying and verifying the dimensions of the multilayer structures. When periodic structures form part of the multilayer structures, the dimensions can also be cross-verified by x-ray diffraction (XRD).

### SUMMARY OF THE INVENTION

An object of the invention is to provide accurate magnification calibrations over the magnification ranges from sub-nanometer to several micrometers, for electron and scanning probe microscopes.

Accordingly, the present invention provides a calibration device for electron and scanning probe microscopes comprising a single crystal semiconductor substrate having grown thereon a series of periodic arrangements of layers, with periods of known thicknesses.

In a preferred embodiment, the sample consists entirely of a single crystal material with epitaxial layers grown upon it, so that length measurements of epitaxial layers grown into the crystal can be verified by TEM by imaging the crystal lattice spacing of the crystal substrate.

In a preferred embodiment, the device consists of a cross-sectional sample based on a single crystal semiconductor substrate upon which are grown a group of thin layers, followed by a group of thicker layers, followed by more groups of even thicker layers, so that the sample, when imaged in an SEM, appears as a series of groups of alternating light and dark contrast layers with different periodic spacings, to allow calibrations over many length regimes.

In a preferred embodiment, alternating layers are either etched or oxidized to provide topographic contrast in an AFM.

The invention defines a new magnification standard for electron and scanning probe microscopes. When viewed in an electron microscope, the calibration device appears as a series of darker bands alternating with lighter bands, and when viewed with a scanning probe microscope, these layers appear as a series of plateaus and valleys. In both cases, all band thicknesses and spacings are very accurately known, and the periods of the structures are very accurately determined through TEM and/or XRD characterization.

In a preferred embodiment, the sample consists of a single crystal of gallium arsenide (GaAs) upon which are grown a series of periodic structures consisting of GaAs and aluminum gallium arsenide (AlGaAs), and/or GaAs and indium gallium arsenide (InGaAs). On a GaAs substrate a small period superlattice is grown, consisting of 20 sets of very thin layers (approximately 5 nm thick) of AlGaAs alternating with similar thickness GaAs layers. This is followed by a second superlattice consisting of 10 sets of thin layers (approximately 17.5 nm thick) of AlGaAs alternating with similar thickness GaAs layers. This pattern is repeated for superlattices composed of 10 sets of approximately 50 nm thick layers and 5 sets of approximately 175 nm thick layers. An approximately 1 micrometer thick surface layer contains periodic ultra-thin (of the order of 1 nanometer) highly strained InGaAs layers separated by much thicker GaAs layers. This surface superlattice provides a strong XRD signal, which provides another reference length for accurately determining the lengths of the other periodic structures. This second reference length is also visible by TEM and is used to confirm and verify the TEM length measurements obtained by reference to the crystal lattice spacing of the substrate.

There are several additional specialized functions that the device in accordance with the invention can perform in electron or scanning probe microscopes. When the device is used in conjunction with an x-ray analyzer in an electron microscope, it can aid in the characterization of electron beam size and beam spreading. When the device is used in an AFM, it can aid in the characterization of the scanning tip profile.

### BRIEF DESCRIPTION OF DRAWING

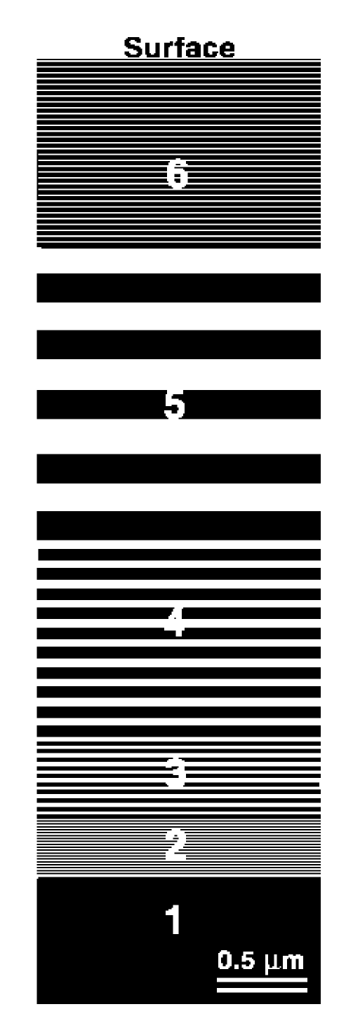

The invention will now be described in detail, by way of example only, with reference to the accompanying drawing in which FIG. 1 represents the cross-sectional view of a layered structure grown on a GaAs crystal substrate.

### DESCRIPTION OF THE PREFERRED EMBODIMENT

A detailed description will now be given of an embodiment of the calibration device with reference to FIG. 1. Referring to FIG. 1, a series of band structures are visible. The crystal growth direction is up in this FIGURE, and the line marked ‘Surface’ is the top surface of the as-grown structure.

The device consists of a single crystal grown on a Gas substrate by a semiconductor crystal growth technique. The epitaxial structures are produced by introducing an additional material other than gallium or arsenic into the growth chamber, such as aluminum or indium, to produce epitaxial layers of AlₓGa₁₋ₓAs (AlGaAs) or In_{y}Ga_{1-y}As (InGaAs). The epitaxial layers should not exceed the critical thickness for that material in relation to the GaAs layers, where the strain induced by the different crystal lattice spacing of the epitaxial layer causes breakdown of the single crystal structure with the formation of dislocations and other crystal defects.

The calibration sample consists of a plurality of groups of thin, epitaxial, atomically abrupt AlGaAs layers alternating with GaAs layers of nominally the same thickness. The period of each set of layers is kept constant. The initial set of layers (2) is grown on a GaAs substrate (1). The AlGaAs and GaAs layers have very similar lattice constants, so a variety of thicknesses of AlGaAs layers can be grown without epitaxial breakdown. Several additional groups of alternating AlGaAs and GaAs layers (3,4 and 5) are grown to allow calibrations over a broad range of lengths. The thickest AlGaAs layers may be comprised of thinner alternating AlGaAs and GaAs layers, to minimize the effects of aluminum oxidation. The thick 1-micrometer surface layer of GaAs contains ultra-thin InGaAs layers of a few atomic layers thickness (6) approximately every 35 nm. This additional superlattice generates a strong XRD signal, and is used as a cross-reference for verifying all other dimensions on the device. The InGaAs layers have a substantially different lattice constant than GaAs, so only very thin InGaAs layers can be grown to allow the InGaAs lattice spacing to be strained to match the lattice spacing of the GaAs layers, and to avoid epitaxial breakdown.

After the crystal growth is complete, the material is cut into appropriately sized pieces and two of these pieces are mounted surface-to-surface to provide a cross-sectional device comprised of two complete structures inverted in relation to each other. This cross-section is polished flat. For electron microscope samples, contrast in the image is provided by elemental contrast between the layers. For AFM samples, alternating layers are selectively etched or oxidized to provide topographic contrast. When viewed in an electron or scanning probe microscope, the sample appears as a series of groups of alternating bands of known thickness, with each group having a different, accurately known period. The lengths of the periods for the different groups are used as reference lengths in the microscopes. Using the periods as the reference lengths avoids inaccuracies due to uncertainties in defining the edges of individual layers.

The device can be prepared as a cross-sectional TEM sample for accurate layer thickness measurements. When the TEM sample is viewed down a crystal zone axis, a lattice image can be formed. By measuring the atomic lattice spacings of the substrate material, all layers in the sample can be very accurately calibrated against this known natural constant. This provides direct traceability to a constant of nature, with the reference unit length available on the sample itself. SEM or AFM calibration devices can then be made from regions on the wafer where the layer thicknesses are very accurately known through TEM measurements. The very accurate length measurements obtained by using the TEM thickness verification samples are thereby transferred to the SEM and AFM calibration devices.

The approximately 1 micrometer thick surface layer contains periodic ultra-thin highly strained InGaAs layers separated by much thicker GaAs layers. This surface periodic structure provides a strong XRD signal, which provides an additional, alternate reference length for verifying the dimensions of the other periodic structures. This surface periodic structure is visible by TEM, and can be used to confirm and verify the TEM length measurements obtained by reference to the crystal lattice spacing of the substrate.

When the device is aligned perpendicular to an electron beam or a scanning probe, the different periods of the layered structures incorporated into the device allow it to be used to calibrate microscope ranges from ranges displaying sub-nanometer lengths up to ranges displaying lengths of several micrometers. The most valuable attribute of the sample is that all period thickness values are very accurately known for many magnification ranges, and all period thicknesses are directly traceable to a constant of nature, the crystal lattice spacing of the substrate material of the device itself. Another valuable attribute is that by referencing to measurements of multiple periods rather than individual layer measurements, uncertainties in individual layer edge definition are eliminated.

There are several additional specialized functions that the device in accordance with the invention can perform in electron or scanning probe microscopes. When used in conjunction with an x-ray analyzer in an electron microscope, it can aid in the characterization of electron beam size and beam spreading. When used in an AFM, it can aid in the characterization of the scanning tip profile. Although the entire device is described as a GaAs-based single crystal, other suitable substrates may be used, and the multilayer structure grown on the substrate does not necessarily have to be single crystal or epitaxial.

What is claimed is:

1. A calibration device for electron and scanning probe microscopes comprising a crystal having formed thereon a plurality of periodic arrangements of layers of known thickness.

2. A calibration device as claimed in claim 1, wherein different arrays of periodic structures can be stacked together to define calibration structures for different ranges of magnification.

3. A calibration device as claimed in claim 1 wherein said single crystal comprises a gallium arsenide (GaAs) crystal substrate upon which is grown a series of periodic structures consisting of abrupt GaAs and aluminum gallium arsenide (AlGaAs) layers, and/or abrupt GaAs and indium gallium arsenide (InGaAs) layers.

4. A calibration device as claimed in claim 3 wherein the period thicknesses of each set of periodic structures are directly referenced to the crystal lattice spacing of the substrate material as measured by cross-sectional TEM, or to the dimensions of periodic structures as determined by XRD.

5. A method of calibrating a microscope comprised of viewing in cross-section a crystal having formed thereon a series of periodic arrangements of layers of known thicknesses, using the contrast variation from the different elements in the layered structures as imaged by electron microscopy, or the topographic features of this layered structure as imaged by scanning probe microscopy, to obtain length calibrations.

6. A method of calibrating a microscope as claimed in claim 5, wherein the known period thickness values of the calibration sample are compared with the microscope's nominal magnification values, to obtain accurate magnification correction values for the microscope's nominal magnification values.

7. A method of calibrating specialized functions of a microscope by using the elemental variation in the sample or the topographic features to obtain additional microscope calibrations.
